(19) United States
(12) Patent Application Publication
(10) Pub. No.: US 2011/0155980 A1
(43) Pub. Date: Jun. 30, 2011

(54) COMBINATION SCISSOR LIFT

(76) Inventor: Kenneth Thurm, Anaheim, CA (US)

(21) Appl. No.: 12/648,056

(22) Filed: Dec. 28, 2009

(51) Int. Cl. B66F 7/18; B66F 7/28

(52) U.S. Cl. 254/93 L; 254/133 R; 254/134

(57) ABSTRACT

A motorcycle lift comprising first and second frames that are stackable upon each other is disclosed. The first frame may have a wheel support which may support front and rear wheels of the motorcycle. The first frame is operative to lift the motorcycle to a first height by activation of a first jack. The second frame may be mechanically connected to the first frame and traversed to a second height by further activation of the first jack to support the motorcycle by the frame rails that cradle the engine of the motorcycle and lift the wheels off of the wheel support.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to a motorcycle lift for lifting and supporting motorcycles.

The support or lifting of a motorcycle above ground level is beneficial to enable convenient and adequate access for making needed repairs or to display a motorcycle. For example, in making repairs to the engine block, access to the front and/or rear wheel assemblies, brake systems, and related wheel components (e.g., suspension components) is far more difficult and time-consuming if the wheels of the motorcycle are not suspended.

Prior art motorcycle lifts for raising motorcycles to varying heights based on the repair that needs to be done to the motorcycle are cumbersome to adjust. Prior art motorcycle lifts do not allow convenient and efficient adjustment. In a production type environment, such cumbersome operation is inefficient and undesirable.

Accordingly, there appears to be a need in the art for a new motorcycle lift that more efficiently enables the user to lift the motorcycle to different heights as desired to repair particular components of the motorcycle.

### BRIEF SUMMARY

The motorcycle lift disclosed herein addresses the needs discussed above, discussed below and those that are known in the art. The lift comprises first and second frames. Both frames have a scissor configuration which allows the second upper frame to be raised or lowered by the scissor action of the first lower frame. The first frame or a lower frame rests on the ground or support surface and has two cross bars that are traversed closer to each other as the first frame is being raised. Conversely, the two cross bars are traversed further apart from each other as the first frame is being lowered.

The second frame has a scissor configuration and is rotatably mounted to the cross bars of the first frame. As the two cross bars are traversed closer to each other, the first frame is being raised. Due to the rotatable connection between the two cross bars and the second frame or upper frame, the second upper frame is also raised when the first frame is raised. Actuation or raising of the first frame also raises the second frame due to the mechanical connection between the two cross bars and the second frame. Conversely, as the two cross bars are traversed further apart from each other, the first frame is being lowered. Due to the rotatable connection between the two cross bars and the second frame, the second upper frame is also being lowered. Actuation or lowering of the first frame also lowers the second frame due to the mechanical connection between the two cross bars and the second frame.

The first and second frames are mechanically connected to a single lifting system. More particularly, the single lifting system may be connected to the first frame and operative to raise and lower the first frame. Since the first and second frames are mechanically linked to each other as discussed, raising and lower of the first frame by the single lifting system also raises and lowers the second frame.

In operation, the first and second frames may be traversed to a first position or fully lowered position. The motorcycle may be rolled on a wheel support of the first frame. The lifting system raises the first frame to a second position or a first height. The wheel support supports the front and rear wheels of the motorcycle. The second frame may be directly under the engine of the motorcycle. When the user is ready to repair the wheels, brakes or related components, the single lifting system may be further actuated to continue raising the first frame which also raises the second frame. The second frame contacts the frame of the motorcycle and lifts the motorcycle so that the wheels of the motorcycle are lifted off of the wheel support of the first frame. The wheels are now suspended and the user can conveniently work on the wheels, brakes, and related components (e.g., suspension components). After the repair work is accomplished, the user may release the single lifting system to fully lower the first and second frames and roll the motorcycle off of the lift.

More particularly, a motorcycle lift for raising and supporting a motorcycle during maintenance is disclosed. The lift may comprise a first frame, second frame and a lifting system. The first frame may have a scissor configuration and be traversable between a first position, second position and a third position. The first frame may have a first common crossbar and a second common crossbar that are traversed closer to or further away from each other as the first frame is traversed between the first, second and third positions. The first frame may further comprise a wheel support mountable to the first and second common crossbars for supporting the wheels of the motorcycle when the first frame is in the first and second positions. The wheel support may be raised and lowered as the first frame is traversed between the first, second and third positions.

The second frame may have a scissor configuration and be mountable to the first and second crossbars. The second frame may have a chassis support for supporting a frame of the motorcycle when the first frame is traversed to the third position. More particularly, the chassis support contacts and lifts frame rails of the motorcycle frame when the first frame is traversed to the third position. The frame rails are a part of the motorcycle frame that cradles the motorcycle engine and is under the engine. Also, the frame rails are located at the center of the motorcycle frame. The second frame may lift the front and rear wheels of the motorcycle off of the wheel support when the first frame is traversed to the third position.

The lifting system may be attached to the first frame and operative to traverse the first frame between the first, second and third positions thereby actuating the second frame.

The second frame may include inner and outer first and second extensions pivotable attached to each other and which are pivoted upon traversal of the first frame between the first, second and third position.

The second frame may further comprise cradles and hooks attached to distal end portions of the inner and outer first and second extensions of the second frame. The cradles and hooks may be rotatably attached to the first and second common crossbars. First, second, third and fourth cradles and hooks can be traversed between an open and closed position. In the open position, the cradles and hooks may receive the first and second common cross bars. In the closed position, the cradles and hooks may be rotatably secured to the first and second common cross bars so that as the first frame is traversed between the first, second and third positions, the first and second common cross bars are traversed closer to and further apart from each other to raise and lower the second frame.

The second frame may further comprise first, second, third and fourth tightening knobs for securing the first, second, third and fourth hooks to the closed position. The first, second, third and fourth tightening knobs may be respectively mountable to the outer support first extension first end, the outer support second extension first end, the inner support first extension first end and the inner support second extension first end. Each of the first, second, third and fourth knobs may be operative to tighten first, second, third and fourth contoured hooks. The first, second, third and fourth cradles may be respectively attached to the outer support first extension first end, the outer support second extension first end, the inner support first extension first end and the inner support second extension first end. The first and second hooks and cradles may receive the first common crossbar and permit relative rotational movement of the first common crossbar within the first and second hooks and cradles. The third and fourth hooks and cradles may receive the second common cross bar and permit relative rotational movement of the second common crossbar within the third and fourth hooks and cradles for transferring movement of the first frame to the second frame as the first and second common cross bars are traversed closer to or further apart from each other.

The second frame may include an outer support first extension, an outer support second extension, an inner support first extension, an inner support second extension and the chassis support. The outer support first extension may have an outer support first extension first end rotatably mountable to the first common crossbar about the first common crossbar axis and an outer support first extension second end mountable to a sixth crossbar defining a sixth crossbar axis.

The outer support second extension may be parallel to and opposing the outer support first extension. The outer support second extension may have an outer support second extension first end rotatably mountable to the first common crossbar about the first common crossbar axis and an outer support second extension second end mountable to the sixth crossbar.

The inner support first extension may be mountable to the outer support first extension at a third fulcrum along a third fulcrum axis. The inner support first extension may have an inner support first extension first end rotatably mountable to the second common crossbar about the second common crossbar axis and an inner support first extension second end mountable to a fifth crossbar defining a fifth crossbar axis.

The inner support second extension may be parallel to and oppose the inner support first extension. The inner support second extension may be mountable to the outer support second extension at a fourth fulcrum along a fourth fulcrum axis, with the third fulcrum axis and the fourth fulcrum axis being concentric to each other and the fifth crossbar axis and the sixth crossbar axis being generally parallel to the third fulcrum axis and the fourth fulcrum axis. The inner support second extension may have an inner support second extension first end rotatably mountable to the second common crossbar about the second common crossbar axis and an inner support second extension second end mountable to the fifth crossbar about the fifth crossbar axis. The chassis support may be mountable to the fifth crossbar and the sixth crossbar. The chassis support may have a chassis support first end proximate to the fifth crossbar and a chassis support second end opposing the chassis support first end.

The second frame may further comprise a first longitudinal track and a first wheel assembly. The first longitudinal track may be disposed on a bottom side of the chassis support. The first wheel assembly may be rollably disposable in the first longitudinal track. The first wheel assembly may move along the first longitudinal track as the lift is traversed between the first, second and third positions.

The second frame may further comprise a second longitudinal track and a second wheel assembly. The second longitudinal track may be disposed on the bottom side of the chassis support. The second wheel assembly may be rollably disposable in the second longitudinal track. The second wheel assembly may move along the second longitudinal track as the lift is traversed between the first, second and third positions.

The second frame may further include a plurality of stabilizing latches operative to stabilize the position of the motorcycle frame on the chassis support of the second frame.

The lifting system may have a lift arm end mounted to a seventh crossbar between an inner support first arm and an inner support second arm of the first frame. The lifting system may further have a base end mounted proximate to the second common crossbar. The lifting system may be a hydraulic jack. The lifting system may be an air over hydraulic jack.

Additionally, a method of raising a motorcycle during maintenance so that a user may lift the motorcycle to a first height or a second higher height depending on the motorcycle components being worked on and lowering the motorcycle when maintenance is completed is disclosed. The method may comprise the steps of rolling a motorcycle onto a wheel support of a first frame of a motorcycle lift; actuating a first jack to lift the motorcycle to a first height with the front and rear wheels of the motorcycle supported by the wheel support; raising the motorcycle to the first height by raising the wheel support to the first height; actuating the first jack to lift the motorcycle to a second height with the front and rear wheels lifted off of the wheel support; supporting a frame of the motorcycle with a chassis support of a second frame of the motorcycle lift; and raising the chassis support of the second frame and the first frame to the second height so that the motorcycle is supported by the motorcycle frame and the front and rear wheels of the motorcycle are lifted off of the wheel support.

Additionally, a removable second frame of a motorcycle lift is disclosed. The removable second frame is mountable a first frame having a wheel support and a lifting system. The first frame may have a first common crossbar and a second common crossbar which are traversable closer to or further apart by operation of the lifting system. The removable second frame may comprise an outer support first extension, an outer support second extension, an inner support first extension and an inner support second extension.

The outer support first extension may have an outer support first extension first end rotatably mountable to the first common crossbar defining a first common crossbar axis and an outer support first extension second end mountable to a sixth crossbar defining a sixth crossbar axis. The outer support second extension may be parallel to and opposing the outer support first extension. The outer support second extension may have an outer support second extension first end rotatably mountable to the first common crossbar about the first common crossbar axis and an outer support second extension second end mountable to the sixth crossbar. The inner support first extension may be mountable to the outer support first extension at a third fulcrum along a third fulcrum axis. The inner support first extension may have an inner support first extension first end rotatably mountable to a second common crossbar about a second common crossbar axis and an inner support first extension second end mountable to a fifth crossbar defining a fifth crossbar axis. The chassis support may be mountable to the fifth crossbar and the sixth crossbar. The chassis support may have a chassis support first end proximate to the fifth crossbar and a chassis support second end opposing the chassis support first end. The inner support second extension may be parallel to and opposing the inner support first extension. The inner support second extension may be mountable to the outer support second extension at a fourth fulcrum along a fourth fulcrum axis. The inner support second extension may have an inner support second extension first end rotatably mountable to the second common crossbar about the second common crossbar axis and an inner support second extension second end mountable to the fifth crossbar about the fifth crossbar axis.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a side perspective view of an embodiment of the motorcycle lift with a first scissor frame and a second scissor frame disposed on top of each other and operable with a single handle or single jacking system, the motorcycle lift being positioned at a second position;

FIG. 2 is a side view of an embodiment of the motorcycle lift shown in FIG. 1 with a motorcycle frame positioned on a chassis support with the front and rear wheels elevated off of the wheel support, the motorcycle lift being positioned at a third position;

FIG. 3 is a perspective view of an embodiment of the motorcycle lift with the first frame and the second frame disposed in a folded position or first position;

FIG. 4 is a bottom view of the second frame shown in FIG. 1;

FIG. 5 is a frontal view of the second frame shown in FIG. 1; and

FIG. 6 is a reverse side perspective view of the embodiment of the motorcycle lift shown in FIG. 1.

### DETAILED DESCRIPTION

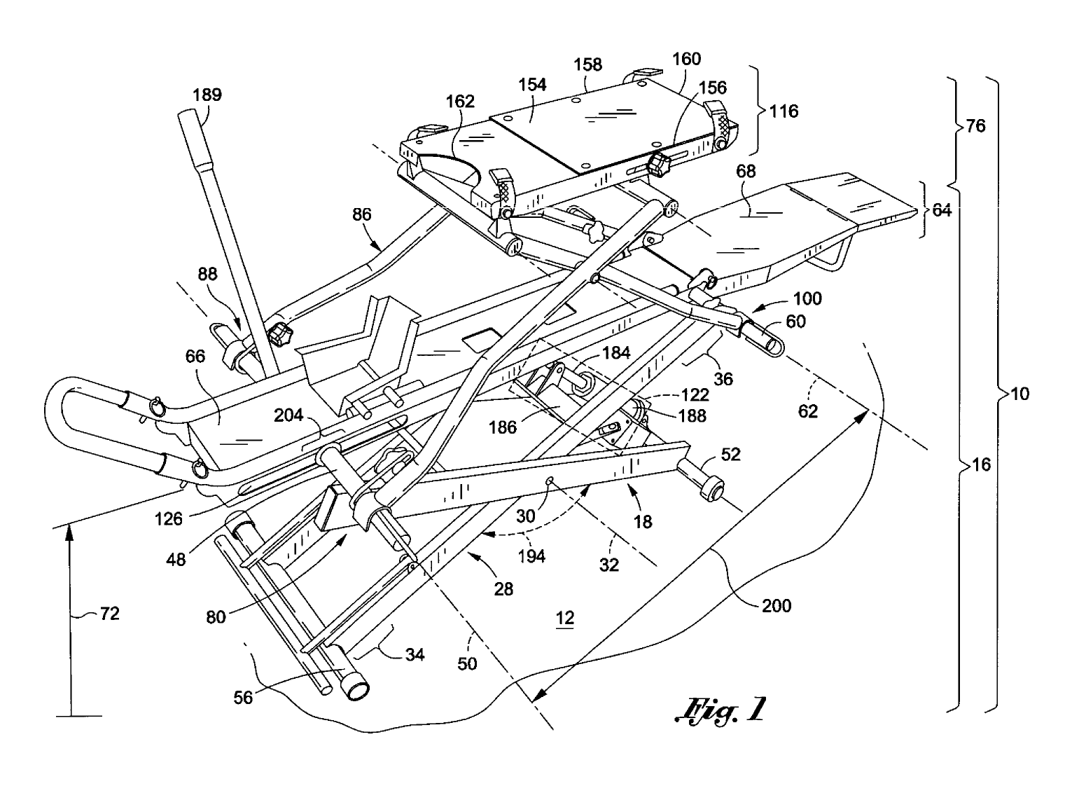

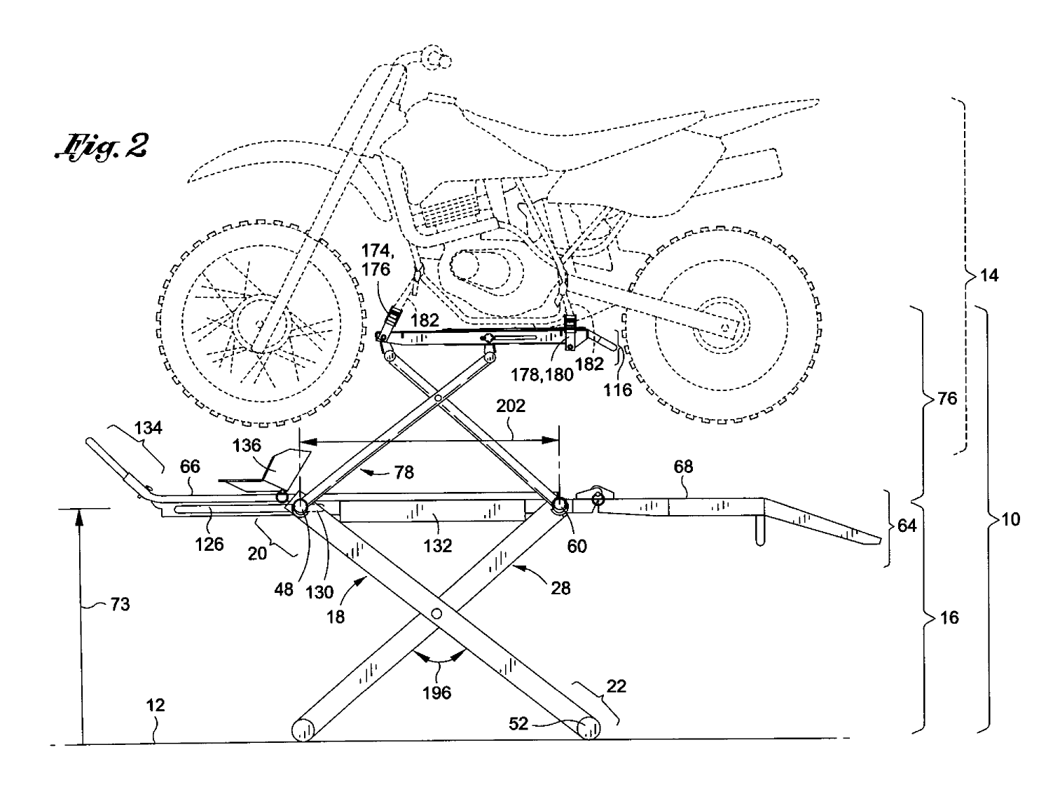

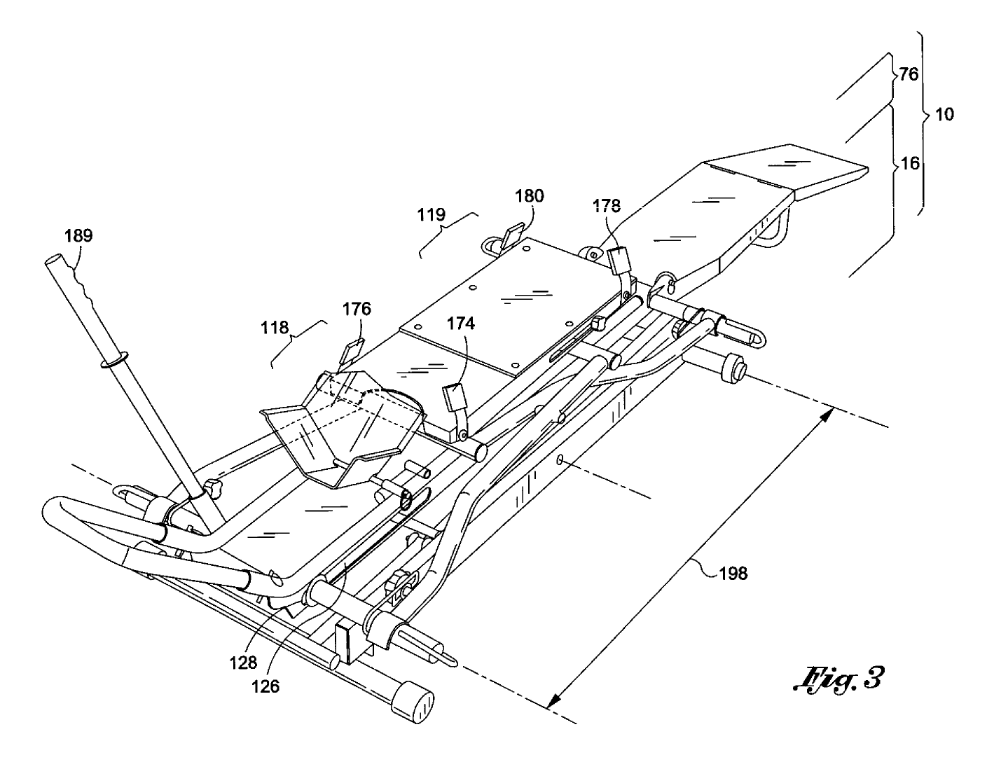

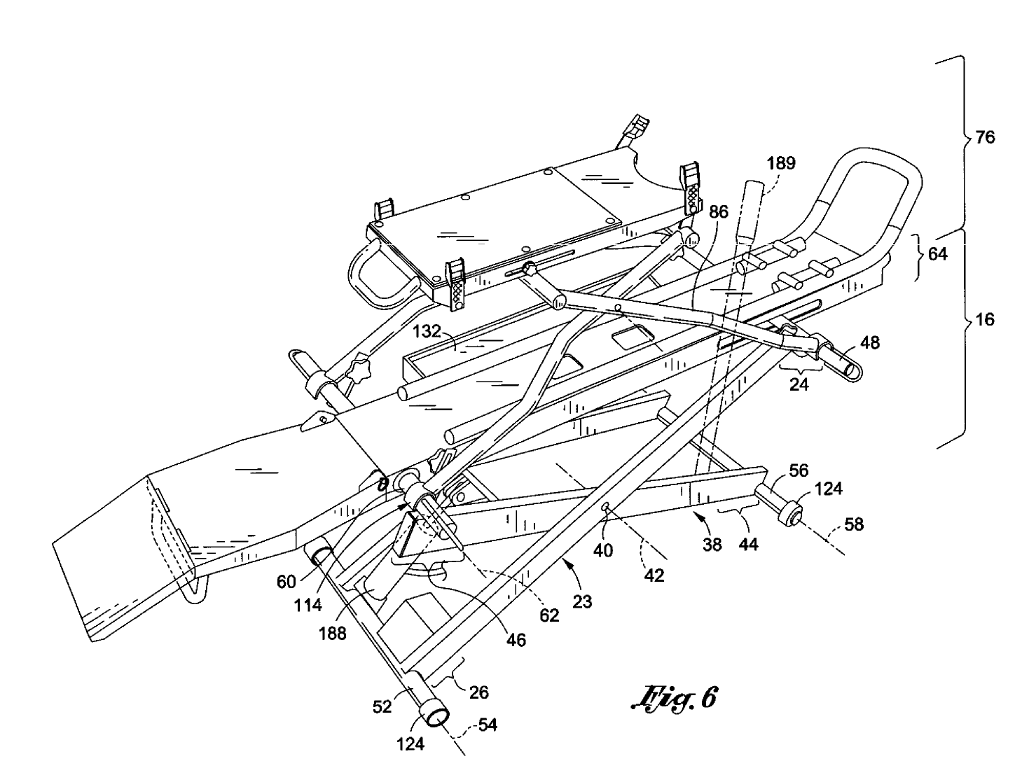

The drawings referred to herein are for the purposes of illustrating the preferred embodiments of the present invention and not for the purposes of limiting the same. FIGS. 1 and 2 depicts an embodiment of the motorcycle lift 10 positioned on a surface 12 to lift and support a motorcycle 14 (see. FIG. 2). As shown in FIG. 2, a first frame 16 has an outer support first arm 18 defining an outer support first arm first end 20 and an outer support first arm second end 22. An outer support second arm 23 (see FIG. 6) that is parallel to and opposing the outer support first arm 18 has an outer support second arm first end 24 and an outer support second arm second end 26. An inner support first arm 28 (see FIG. 2) is connectible and rotatably mountable to the outer support first arm 18 at a first fulcrum 30 (see FIG. 1) along a first fulcrum axis 32. An inner support second arm 38 (see FIG. 6) is connectable and rotatably mountable to the outer support second arm 23 at a second fulcrum 40 along a second fulcrum axis 42. The first fulcrum axis 32 (see FIG. 1) and the second fulcrum axis 42 (see FIG. 6) may be concentric with each other. By pivoting the inner and outer support first and second arms 18, 28, 23, 38, the first frame 16 is disposable in a first position (see FIG. 3), second position (see FIG. 1) and third position (see FIG. 2). In the first position, the first frame 16 is in a “folded” configuration (see FIG. 3) and generally compact. The lift 10 may be stored in a corner. Also, the motorcycle may be rolled onto the lift 10 in the first position. In the second position (see FIG. 1), the first frame 16 may be disposed at a first angle 194 (see FIG. 1). The wheels of the motorcycle may be supported by the wheel support 64. In the third position (see FIG. 2), the first frame 16 may be disposed at a second angle 196 that is less than a first angle 194. A second frame 76 (see FIG. 2) which is mounted to the first frame 16 and actuated in response to the first frame 16 holds up the frame of the motorcycle such that the wheels of the motorcycle are no longer supported by the wheel support 64. More particular, the second frame 76 contacts frame rails of the motorcycle frame which cradle the motorcycle engine. The frame rails are also located below the engine and is generally central to the motorcycle frame. The second frame 76 lifts the motorcycle frame by way of the frame rails so that the wheels of the motorcycle are no longer supports by the wheel support 64. The mechanic or user may work on the front and rear wheels or related components (e.g., suspension components) of the motorcycle. The first and second frames 16, 76 are both operated by a single lifting system 122 (see FIG. 1) to efficiently traverse the lift 10 between the three positions shown in FIGS. 1-3.

Referring now to FIG. 1, the inner support first arm 28 has an inner support first arm first end 34 and an inner support first arm second end 36. The inner support second arm 38 (see FIG. 6) may have an inner support second arm first end 44 and an inner support second arm second end 46.

As shown in FIG. 1, the first frame 16 may have a first common crossbar 48 defining a first common crossbar axis 50 and a second common crossbar 60 defining a second common crossbar axis 62. The first common crossbar 48 may be mounted to the outer support first arm first end 20 (see FIG. 2) and the outer support second arm first end 24 (see FIG. 6). The second common crossbar 60 may be mounted to the inner support second arm second end 46 (see FIG. 6) and the inner support first arm second end 36 (see FIG. 1). In the second and third positions (FIGS. 1 and 2), the first common crossbar axis 50 may be closer to the second common crossbar axis 62 than when the first frame 16 is in the first or folded position (FIG. 3). More specifically, the first common crossbar 48 and the second common crossbar 60 may be separated by a first distance 198 (see FIG. 3) with the first frame 16 in the first position. The first distance 198 is greater than a second distance 200 (see FIG. 1) when the lift is in the second position. The first and second distances 198, 200 are greater than a third distance 202 (see FIG. 2) when the lift 10 is in the third position. As the angle between the outer support first arm 18 and the inner support first arm 28 is reduced (angle 194 to angle 196), the distance between the first common crossbar 48 and the second common crossbar 60 is correspondingly reduced as well and vice versa.

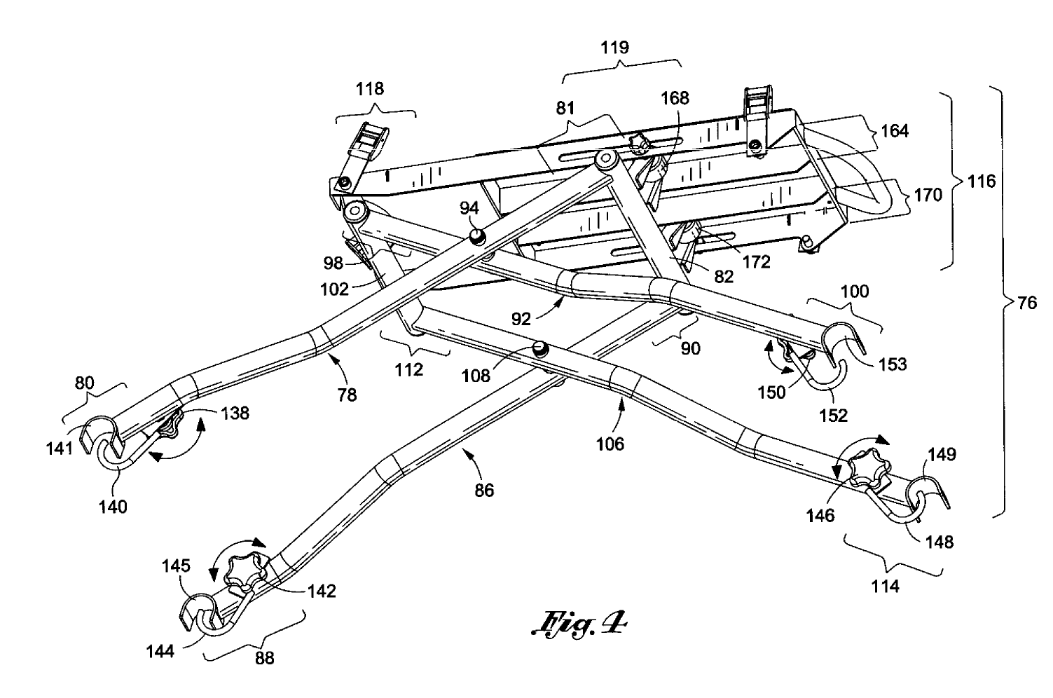

The second frame 76 (see FIGS. 2 and 4) is rotatably mountable to the first common crossbar 48 by an outer support first extension 78. The outer support first extension 78 may have an outer support first extension first end 80 and an outer support first extension second end 81, as shown in FIG. 4. The outer support first extension first end 80 is rotatably mountable to the first common crossbar 48, as shown in FIG. 1. Similarly, the second frame 76 also has an outer support second extension 86 (see FIGS. 4 and 6) parallel to and opposing the outer support first extension 78. The outer support second extension 86 has an outer support second extension first end 88 that is rotatably mountable to the first common crossbar 48 about the first common crossbar axis 50. The outer support second extension 86 may have an outer support second extension second end 90.

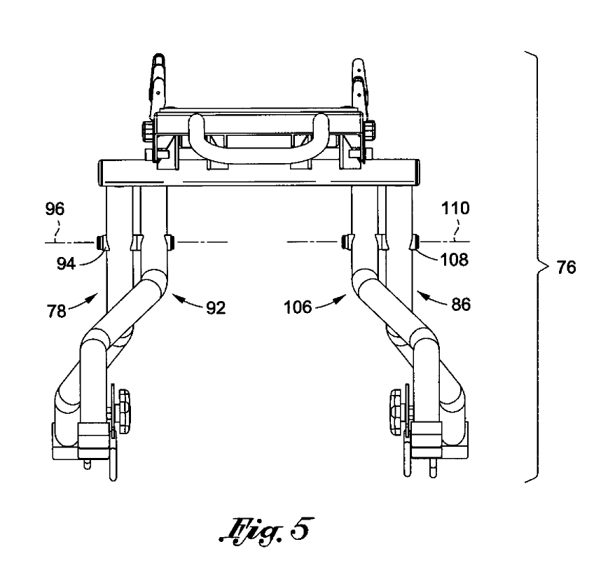

The second frame 76 may have an inner support first extension 92 that is rotatably mountable to the outer support first extension 78 at a third fulcrum 94 along a third fulcrum axis 96 (see FIG. 5). The inner support first extension 92 may have an inner support first extension second end 100 rotatably mountable to the second common crossbar 60 about the second common crossbar axis 62 (see FIGS. 1 and 4).

The second frame 76 may further have an inner support second extension 106 that is parallel to and opposing the inner support first extension 92, as shown in FIG. 4. The inner support second extension 106 may be mountable to the outer support second extension 86 at a fourth fulcrum 108 along a fourth fulcrum axis 110 (see FIG. 5). The inner support second extension 106 may have an inner support second extension second end 114 that is rotatably mountable to the second common crossbar 60 about the second common crossbar axis 62, as shown in FIG. 6. The inner support second extension 106 may further have an inner support second extension first end 112. The third fulcrum axis 96 and the fourth fulcrum axis 110 may be concentric to each other (see FIG. 5).

Referring now to FIGS. 2 and 6, a third crossbar 52 defining a third crossbar axis 54 is shown to be mounted to the outer support second arm second end 22 (see FIG. 2) and the outer support second arm second end 26 (see FIG. 6). The third crossbar 52 may have a wheel assembly 124 (see FIG. 6). This enables the motorcycle lift 10 to be rolled on the surface 12. Accordingly, the motorcycle lift 10 may be transported from one location to another by a single user with relative ease.

The motorcycle lift 10 also has a fourth crossbar 56 (see FIG. 6) defining a fourth crossbar axis 58 mounted to the inner support first arm first end 34 (see FIG. 1) and the inner support second arm first end 44 (see FIG. 6). The fourth crossbar 56 may include a wheel assembly 124 (see FIG. 6), thereby enabling the motorcycle lift 10 to be conveniently rolled on the surface 12.

The wheel support 64 of the lift 10 may be mountable to the first common crossbar 48 and the second common crossbar 60. The wheel support 64 may have a wheel support first end 66 (see FIG. 1) and a wheel support second end 68 (see FIG. 1) for supporting the rear and front wheels of the motorcycle. The wheel support 64 may be extendable to a first height 72 (see FIG. 1) above the surface 12 with the first frame 16 disposed in the second position (see FIG. 1). At the first height 72 or second position, the front and rear wheels of the motorcycle are supported by the wheel support first and second ends 66, 68. The second frame 76 of the motorcycle lift 10 further has a chassis support 116 mountable to a fifth crossbar 102 and a sixth crossbar 82, as shown in FIG. 4. The chassis support 116 may have a chassis support first end 118 proximate to the fifth crossbar 102 and a chassis support second end 119 opposing the chassis support first end 118. The chassis support 116 may be operative to support the frame rails of a motorcycle 14, as shown in FIG. 2. The frame rails may be a portion of the motorcycle frame that cradles the motorcycle engine and is also disposed below the motorcycle engine. The wheel support 64 may be extendable to a second height 73 (see FIG. 2) above the surface 12 with the first and second frames 16, 76 traversed to the third position. When the wheel support 64 is extended to the second height 73, the second frame 76 supports the frame of the motorcycle and lifts the front and rear wheels off of the wheel support 64. By way of example and not limitation, the motorcycle wheels may be elevated approximately 6″ (inches) above the wheel support 64 with the first frame 16 and the second frame 76 in the third position.

The motorcycle lift 10 may have a lifting system 122 (see FIG. 1) connected to the first frame 16 operative to simultaneously traverse the first frame 16 and the second frame 76 to the first, second, or third positions. The lifting system 122 may define a lift arm end 184 mounted to a seventh crossbar 186 attached between the inner support first arm 28 and the inner support second arm 38, as shown in FIGS. 1 and 6. The lifting system 122 may have a base end 188 mounted to the second crossbar 52. By way of example and not limitation, the lifting system 122 may be a hydraulic jack. In another embodiment, the lifting system 122 may be an air over hydraulic jack or other type of jack known in the art or developed in the future. The lifting system is operative to change the angle 194, 196 between the inner and outer first and second support arms 18, 28, 23, 38 of the first frame 16. The lifting system 122 may be operated by handle 189.

The wheel support first end 66 may have a wheel support groove 126 (see FIGS. 1 and 2). The first common crossbar 48 may be slidably and rotatably disposed through the wheel support groove 126 proximate a wheel support groove first end 128 (see FIG. 3) with the first frame 16 and the second frame 76 disposed in the first position. The first common crossbar 48 may be slidably and rotatably disposed proximate a wheel support groove center 204 (see FIG. 1) with the first frame 16 and the second frame 76 disposed in the second position (see FIG. 1). The first common crossbar 48 may be slidably and rotatably disposed proximate a wheel support groove second end 130 (see FIG. 2) with the first frame 16 and the second frame 76 disposed in the third position (see FIG. 2).

As shown in FIGS. 2 and 6, the motorcycle lift 10 may have a work tray 132 mounted to the wheel support 64 operative to hold tools and/or parts used in the repair of the motorcycle 14. Work tray not shown in FIG. 1 for clarity. The work tray 132 provides ready access to such tools and/or parts, thereby reducing the amount of time in repairing the motorcycle 14.

The motorcycle lift 10 may have a wheel cradle 134 (see FIG. 2) contoured in an upward direction proximate to the wheel support first end 66 operative to receive the wheel of a motorcycle 14. The wheel cradle 134 may enable the motorcycle 14 to be stabilized on top of the wheel support 64, thereby preventing the motorcycle 14 from rolling off of the wheel support 64. In another embodiment, the motorcycle lift 10 may further include a wheel chock 136 on the wheel support 64 operative to support the position of the wheel of a motorcycle 14. The wheel chock 136 thereby further stabilizes the motorcycle 14 on top of the wheel support 64.

Referring now to FIGS. 4-5, the second frame 76 of the motorcycle lift 10 may have a first tightening knob 138 which may be connectible to a contoured first tightening hook 140. The first tightening knob 138 is mounted to the outer support first extension first end 80. The first tightening hook 140 may be mounted to the first common crossbar 48 (see FIG. 1). A second tightening knob 142 may be connectible to a contoured second tightening hook 144, with the second tightening knob 142 mounted to the outer support second extension first end 88 and the second tightening hook 144 mounted onto the first common crossbar 48. Similarly, a third tightening knob 146 may be connectible to a contoured third tightening hook 148 with the third tightening knob mounted to the inner support first extension second end 114 and the third tightening knob 148 mounted to the second common crossbar 60. The motorcycle lift 14 may further include a fourth tightening knob 150 connectible to a contoured fourth tightening hook 152, with the fourth tightening knob 150 mounted to the inner support second extension first end 112 and the fourth tightening hook 152 mounted to the second common crossbar 60.

The second frame 76 may additionally have first, second, third and fourth cradles 141, 145, 149, 153 that work in conjunction with the first, second, third and fourth tightening hooks 140, 144, 148, 152 to rotatably secure the second frame 76 to the first and second common cross bars 58, 60.

The tightening hooks are operative to transfer the rotational movement of the first frame 16 to the second frame 76. As the first frame 16 is traversed toward the first position, the first and second common cross bars 58, 60 are traversed further apart. Conversely, as the first frame 16 is traversed to toward the second then the third positions, then the first and second common cross bars 58, 60 are traversed closer together. Since the cradles and hooks 141, 140, 145, 144, 149, 148, 153, 152 are rotatably secured to the first and second common crossbars 58, 60, the inner and outer first and second extensions 78, 86, 106, 92 of the second frame 76 are pivoted. As a result, both the first and second frames 16, 76 are traversed toward the second, then third positions. Conversely, as the first and second crossbars 58, 60 are traversed further apart, both the first and second frames 16, 76 are traversed toward the second, then first positions.

The operation of the lifting system 122 enables both the first frame 16 and the second frame 76 to be simultaneously elevated into the second and third positions or lowered to the first position. In the second position, the wheels of the motorcycle contact the wheel support 64 but the frame of the motorcycle does not or slightly contacts the chassis support, as shown in FIG. 2. In the third position, the chassis support contacts the frame rails of the motorcycle frame and lifts the wheels of the motorcycle off of the wheel support. The lift 10 is traversed between the first, second and third positions by operation of the single lifting system 122.

In the third position, both wheels of the motorcycle 14 may be suspended above the wheel support 64, thereby enabling ready access to the front and rear wheel assemblies of the motorcycle 14 for the replacement of tires, making repairs to the front and rear brake systems and related wheel components (e.g., suspension components). The motorcycle lift 10 is thereby able to more efficiently lift the front and rear wheels of the motorcycle 14 since only one lifting system 122 operates the scissor action of both the first and second frames 16, 76, thereby reducing the amount of time adjusting the lift 10 and time spent making repairs. The motorcycle lift 10 obviates the need for the use of a second separate independent lifting system, as the height of both the wheel support 64 and the chassis support 116 may be adjusted into the second or third positions by operation of the single lifting system 122 on the first frame 16. As discussed above, both the first frame 16 and the second frame 76 may likewise be simultaneously traversed to the first position through operation of the single lifting system 122. The configuration of the motorcycle lift 10 in the first position enables the motorcycle lift 10 to be conveniently stored in, for example, the corner of a garage, storage facility, or other location when it is not being used, as the size and dimensions of the motorcycle lift 10 are significantly reduced. As a result, potential users who would have otherwise not had adequate space to stow the lift 10 despite space restrictions.

The motorcycle lift 10 depicted in FIG. 1 has a chassis support 116 that is generally rectangular in shape, having, a first longitudinal side 156, an opposing second longitudinal side 158, a first lateral side 160, and an opposing second lateral side 162. The chassis support 116 may have a coarse chassis support upper surface 154 operative to stabilize the position of the motorcycle frame (e.g., frame rails) on the chassis support 116. The chassis support upper surface 154 may be covered with sandpaper, rubber, or other material providing a coarse texture having a high frictional coefficient. The increased friction between the chassis support upper surface 154 and the frame of the motorcycle 14 may prevent the motorcycle 14 from sliding or slipping off of the chassis support 116 with the second frame 76 disposed in the elevated second and third positions.

As shown in FIG. 4, a bottom side of the chassis support 116 may have a first longitudinal track 164 into which may be disposed a first wheel assembly 168 that is mounted to and extends from the sixth crossbar 82. The first wheel assembly 168 may move along the first longitudinal track 164 with the transfer of the rotational movement from the first frame 16 to the second frame 76 between the first position, the second position and third position.

The bottom side of the chassis support 116 may also include a second longitudinal track 170 into which may be disposed a second wheel assembly 172 extending from and mounted to the opposing side of the sixth crossbar 82 and disposed in the second longitudinal track 170. The second wheel assembly 172 may likewise move along the second longitudinal track 170 with the transfer of the rotational movement from the first frame 16 to the second frame 76 between the first position and the second or third positions, as discussed above.

As shown in FIG. 3, the chassis support 116 may further include a first stabilizing latch 174 and a second stabilizing latch 176 mounted proximate to the chassis support first end 118. A third stabilizing latch 178 and a fourth stabilizing latch 180 is shown mounted proximate to the chassis support second end 119. In FIG. 2, the stabilizing latches 174-180 are shown connected to one or more tethers 182 operative to stabilize the positioning of the motorcycle frame on the chassis support 116. The amount of tension applied to the tethers 182 may determine the force with which the frame of the motorcycle 14 is tied down to the stabilizing latches 174-180. This configuration uniquely enables the motorcycle lift 10 to safely position the motorcycle 14 on the chassis support 116 so as to prevent the motorcycle 14 from slipping or falling off while repairs are made with the second frame 76 extended in the third position.

It is also contemplated that the second frame 76 may be an add-on to the first frame 16. In this regard, the second frame 76 is not required but is optional. When the front and rear wheels or the brakes of the motorcycle are not being worked on, the second frame 76 need not be mounted to the first frame 16. However, the second frame 76 may be conveniently tucked under the motorcycle on the first frame 16 even if the front and rear wheels of the motorcycle and the brakes of the motorcycle are not being worked on. The second frame 76 may be added onto motorcycle lifts having first and second common crossbars 58, 60 that are traversed closer to each other or further apart from each other. The second frame 76 may also be mounted in the reverse from the direction shown in FIGS. 1 and 6. In particular, the outer support first and second extensions 78, 86 are rotatably attached to the second common crossbar 60, and the inner support first and second extensions 92, 106 are rotatably attached to the first common crossbar 48.

Referring to FIG. 1, as the first frame 16 is elevated, the center of gravity of the motorcycle is shifted to the left until the chassis support 116 contacts the frame rails of the motorcycle. At this time, the latches 174, 176, 178, 180 may be secured to the frame rails of the motorcycle frame with tethers 182. As the lift 10 is traversed to the third position, the first frame 16 continues to traverse the second frame 76 and the motorcycle toward the left. This action is counteracted by traversal of the chassis support 116 to the left by the second frame 76 as the second frame 76 is pivoted. The left and right traversal aids in maintaining the center of gravity between the wheel supports 124 supporting the first frame 16.

The above description is given by way of example, and not limitation. Given the above disclosure, one skilled in the art could devise variations that are within the scope and spirit of the invention disclosed herein, including various ways of interconnecting the first and second frames 16, 76. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A motorcycle lift for raising and supporting a motorcycle during maintenance and/or display, the motorcycle lift comprising:
a first frame having a scissor configuration and traversable between a first position, second position and a third position, the first frame having a first common crossbar and a second common crossbar that are traversed closer to or further away from each other as the first frame is traversed between the first, second and third positions, the first frame further comprising a wheel support mountable to the first and second common crossbars for supporting the wheels of the motorcycle when the first frame is in the first and second positions, the wheel support being raised and lowered as the first frame is traversed between the first, second and third positions;
a second frame having a scissor configuration and mountable to the first and second crossbars, the second frame having a chassis support for supporting a frame of the motorcycle when the first frame is traversed to the third position, the second frame lifting front and rear wheels of the motorcycle off of the wheel support when the first frame is traversed to the third position; and
a lifting system attached to the first frame and operative to traverse the first frame between the first, second and third positions thereby actuating the second frame.

2. The lift of claim 1 wherein the second frame includes inner and outer first and second extensions pivotably attached to each other and which are pivoted upon traversal of the first frame between the first, second and third position.

3. The lift of claim 2 further comprising cradles and hooks attached to distal end portions of the inner and outer first and second extensions of the second frame, the cradles and hooks being rotatably attached to the first and second common crossbars.

4. The lift of claim 3 wherein first, second, third and fourth cradles and hooks can be traversed between an open and closed position, in the open position, the cradles and hooks may receive the first and second common cross bars and in the closed position, the cradles and hooks may be rotatably secured to the first and second common cross bars so that as the first frame is traversed between the first, second and third positions, the first and second common cross bars are traversed closer to and further apart from each other to raise and lower the second frame.

5. The lift of claim 4 further comprising first, second, third and fourth tightening knobs for securing the first, second, third and fourth hooks to the closed position.

6. The lift of claim 1 wherein the second frame includes:
an outer support first extension, the outer support first extension having an outer support first extension first end rotatably mountable to the first common crossbar about the first common crossbar axis and an outer support first extension second end mountable to a sixth crossbar defining a sixth crossbar axis,
an outer support second extension parallel to and opposing the outer support first extension, the outer support second extension having an outer support second extension first end rotatably mountable to the first common crossbar about the first common crossbar axis and an outer support second extension second end mountable to the sixth crossbar,
an inner support first extension mountable to the outer support first extension at a third fulcrum along a third fulcrum axis, the inner support first extension having an inner support first extension first end rotatably mountable to the second common crossbar about the second common crossbar axis and an inner support first extension second end mountable to a fifth crossbar defining a fifth crossbar axis;
an inner support second extension parallel to and opposing the inner support first extension, the inner support second extension being mountable to the outer support second extension at a fourth fulcrum along a fourth fulcrum axis, with the third fulcrum axis and the fourth fulcrum axis being concentric to each other and the fifth crossbar axis and the sixth crossbar axis being generally parallel to the third fulcrum axis and the fourth fulcrum axis, the inner support second extension having an inner support second extension first end rotatably mountable to the second common crossbar about the second common crossbar axis and an inner support second extension second end mountable to the fifth crossbar about the fifth crossbar axis; and
the chassis support being mountable to the fifth crossbar and the sixth crossbar, the chassis support having a chassis support first end proximate to the fifth crossbar and a chassis support second end opposing the chassis support first end.

7. The lift of claim 6 further comprising:
first, second, third and fourth tightening knobs respectively mountable to the outer support first extension first end, the outer support second extension first end, the inner support first extension first end and the inner support second extension first end, each of the first, second, third and fourth knobs operative to tighten first, second, third and fourth contoured hooks; and
first, second, third and fourth cradles respectively attached to the outer support first extension first end, the outer support second extension first end, the inner support first extension first end and the inner support second extension first end;
wherein the first and second hooks and cradles receive the first common crossbar and permits relative rotational movement of the first common crossbar within the first and second hooks and cradles and the third and fourth hooks and cradles receive the second common cross bar and permits relative rotational movement of the second common crossbar within the third and fourth hooks and cradles for transferring movement of the first frame to the second frame as the first and second common cross bars are traversed closer to or further apart from each other.

8. The lift of claim 1 wherein the second frame further comprises:
a first longitudinal track disposed on a bottom side of the chassis support;
a first wheel assembly rollably disposable in the first longitudinal track, the first wheel assembly moving along the first longitudinal track as the lift is traversed between the first, second and third positions.

9. The lift of claim 8 wherein the second frame further comprises:
a second longitudinal track disposed on the bottom side of the chassis support; and
a second wheel assembly rollably disposable in the second longitudinal track, the second wheel assembly moving along the second longitudinal track as the lift is traversed between the first, second and third positions.

10. The lift of claim 1 wherein the second frame further includes a plurality of stabilizing latches operative to stabilize the position of the motorcycle frame on the chassis support of the second frame.

11. The lift of claim 1 wherein the lifting system has a lift arm end mounted to a seventh crossbar between an inner support first arm and an inner support second arm of the first frame, the lifting system further having a base end mounted proximate to the second common crossbar.

12. The lift of claim 1 wherein the lifting system is a hydraulic jack.

13. The lift of claim 1 wherein the lifting system is an air over hydraulic jack.

14. A method of raising a motorcycle during maintenance so that a user may lift the motorcycle to a first height or a second higher height depending on the motorcycle components being worked on and lowering the motorcycle when maintenance is completed, the method comprising the steps of:
rolling a motorcycle onto a wheel support of a first frame of a motorcycle lift;
actuating a first jack to lift the motorcycle to a first height with the front and rear wheels of the motorcycle supported by the wheel support;
raising the motorcycle to the first height by raising the wheel support to the first height;
actuating the first jack to lift the motorcycle to a second height with the front and rear wheels lifted off of the wheel support;
supporting a frame of the motorcycle with a chassis support of a second frame of the motorcycle lift; and
raising the chassis support of the second frame and the first frame to the second height so that the motorcycle is supported by the frame of the motorcycle and the front and rear wheels of the motorcycle are lifted off of the wheel support.

15. A removable second frame of a motorcycle lift mountable a first frame having a wheel support and a lifting system, the first frame having a first common crossbar and a second common crossbar, traversable closer to or further apart by operation of the lifting system, the removable second frame comprising:
an outer support first extension, the outer support first extension having an outer support first extension first end rotatably mountable to the first common crossbar defining a first common crossbar axis and an outer support first extension second end mountable to a sixth crossbar defining a sixth crossbar axis;
an outer support second extension parallel to and opposing the outer support first extension, the outer support second extension having an outer support second extension first end rotatably mountable to the first common crossbar about the first common crossbar axis and an outer support second extension second end mountable to the sixth crossbar;
an inner support first extension mountable to the outer support first extension at a third fulcrum along a third fulcrum axis, the inner support first extension having an inner support first extension first end rotatably mountable to a second common crossbar about a second common crossbar axis and an inner support first extension second end mountable to a fifth crossbar defining a fifth crossbar axis, a chassis support being mountable to the fifth crossbar and the sixth crossbar, the chassis support having a chassis support first end proximate to the fifth crossbar and a chassis support second end opposing the chassis support first end; and
an inner support second extension parallel to and opposing the inner support first extension, the inner support second extension being mountable to the outer support second extension at a fourth fulcrum along a fourth fulcrum axis, the inner support second extension having an inner support second extension first end rotatably mountable to the second common crossbar about the second common crossbar axis and an inner support second extension second end mountable to the fifth crossbar about the fifth crossbar axis.
